(19) United States
(12) Patent Application Publication
(10) Pub. No.: US 2022/0006162 A1
(43) Pub. Date: Jan. 6, 2022

(54) BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/364,881

(22) Filed: Jul. 1, 2021

(30) Foreign Application Priority Data
Jul. 2, 2020 (JP) 2020-114721
Jan. 20, 2021 (JP) 2021-007269

(51) Int. Cl. H01M 50/583; H01M 10/658; H01M 50/531; H01M 50/543

(52) U.S. Cl. CPC H01M 50/583; H01M 50/543; H01M 50/531; H01M 10/658

(57) ABSTRACT

A highly safe and high energy density battery is provided. A battery (1) includes: a laminated body (100) in which a positive electrode (20) including a positive electrode collector (22), a solid electrolyte (30) and negative electrode (10) including a negative electrode collector (12) are repeatedly arranged, and at least any of the positive electrode collector (22) and negative electrode collector (12) is respectively drawn from an end face of the laminated body (100), and configures a plurality of negative electrode collector tabs (12a, 12b, 12c and 12d); an outer packaging (300) which houses the laminated body (100); and a lead terminal (200) which is electrically connected with the plurality of collector tabs, and having a part extending from the outer packaging (300) to outside, in which the lead terminal (200) is connected with a first overcurrent isolation part (210) arranged inside of the outer packaging (300).

This application is based on and claims the benefit of priority from Japanese Patent Application No. 2020-114721, filed on 2 Jul. 2020, and Japanese Patent Application No. 2021-007269, filed on 20 Jan. 2021, the content of which is incorporated herein by reference.

### BACKGROUND OF THE INVENTION

### Field of the Invention

The present invention relates to a battery.

### Related Art

In recent years, with the spread of electrical and electronic equipment of various sizes such as vehicles, personal computers and portable telephones, the demand for high capacity, high output batteries is rapidly expanding.

As such a battery, the liquid battery cell using an organic electrolytic solution as the electrolyte between the positive electrode and negative electrode has been widely used.

The above-mentioned battery can be used by connecting with a fuse in order to prevent damage of components or injury upon excess current flowing during abnormality.

For example, a secondary battery equipped in order to drive an electric vehicle is being used by connecting with a fuse which breaks the electrical current by melting from overcurrent (for example, refer to Patent Document 1).

Patent Document 1: Japanese Unexamined Patent Application, Publication No. 2014-150664

### SUMMARY OF THE INVENTION

Combustible electrolyte solutions are widely used as the electrolyte of a liquid battery cell.

For this reason, in the case of providing an overcurrent isolation part such as a fuse inside of the battery, there is concern over the electrolytic solution igniting and burning by sparks generated when the fuse is blown.
Therefore, a battery having a combustible electrolytic solution has been used by connecting with a fuse outside of the battery, as disclosed in Patent Document 1.
However, it is preferable for an overcurrent isolation part such as a fuse to be provided at a place close to the location where chemical reaction occurs from the viewpoint of the detection speed of abnormality being fast and an accident risk reduction.
Furthermore, in the case of a plurality of batteries being modularized, if isolating the entire module when an abnormality occurs at one location of the battery, an inconvenience arises in that the entire system is stopped.
However, in the case of connecting with an overcurrent isolation part such as a fuse at the battery exterior for every battery, since installation space is needed, there is a problem in that the energy density of the battery declines.

A solution to the above-mentioned problem in liquid batteries has been desired.

In addition, in recent years, technologies related to solid-state batteries made using a fire-resistant solid electrolyte as the electrolyte are being proposed.
However, the current situation is that a preferable configuration of an overcurrent isolation part for a solid-state battery has not been considered.

The present invention has been made taking account of the above, and has an object of providing a battery of high safety and high energy density.

A first aspect of the present invention relates to a battery including: a laminated body in which a positive electrode including a positive electrode collector, an electrolyte and a negative electrode including a negative electrode collector are repeatedly disposed, at least any among the positive electrode collector and the negative electrode collector is respectively drawn out from an end face, and configures a plurality of collector tabs; an outer packaging which houses the laminated body; and a lead terminal which is electrically connected with a plurality of the collector tabs, and having a part which extends from the outer packaging to outside, in which the lead terminal is connected with a first overcurrent isolation part disposed inside of the outer packaging.

According to the first aspect of the present invention, it is possible to provide a battery of high safety and high energy density.

According to a second aspect of the present invention, in the battery as described in the first aspect, the first overcurrent isolation part is a PTC thermistor.

According to the second aspect of the present invention, it is possible to continuously use a battery without requiring replacement of components after the occurrence of overcurrent.

According to a third aspect of the present invention, in the battery as described in the second aspect, a plurality of the first overcurrent isolation part is provided, each being connected with a different one of the collector tabs.

According to the third aspect of the present invention, upon overcurrent occurring inside the battery, only the abnormal location is isolated, and it is possible to continuously use the normal operating locations.

According to a fourth aspect of the present invention, in the battery as described in the first aspect, the first overcurrent isolation part is a fuse, and a part of the lead terminal configures a part of the first overcurrent isolation part.

According to the fourth aspect of the present invention, it is possible to reduce the number of components of the battery and arrangement space, and thus possible to improve the volumetric energy density of the battery.

According to a fifth aspect of the present invention, in the battery as described in the fourth aspect, the first overcurrent isolation part includes a hole formed in the lead terminal, and the hole is elliptical shape.

According to the fifth aspect of the present invention, it is possible to raise the fuse function of the first overcurrent isolation part, and possible to improve the strength of the lead terminal.

According to a sixth aspect of the present invention, in the battery as described in the fifth aspect, the hole has a long axis direction of the elliptical shape disposed perpendicular to an extending direction of the lead terminal.

According to the sixth aspect of the present invention, it is possible to reliably raise the fuse function of the first overcurrent isolation part, and possible to improve the strength of the lead terminal.

According to a seventh aspect of the present invention, in the battery as described in the fifth or sixth aspect, at least any among an insulating material, a heat insulating material, a reinforcing material and sealing material is filled in at least part of the hole.

According to the seventh aspect of the present invention, it is possible to raise the fuse function of the first overcurrent isolation part.

Alternatively, it is possible to improve the strength of the lead terminal.

According to an eighth aspect of the present invention, in the battery as described in any one of the first to seventh aspects, the outer packaging has an adhered part, and the first overcurrent isolation part is disposed at the adhered part.

According to the eighth aspect of the present invention, it is possible to impart an overcurrent isolation function to the battery even if a liquid-based battery, and possible to improve the volumetric energy density of the battery.

According to a ninth aspect of the present invention, in the battery as described in any one of the first to eighth aspects, a plurality of the collector tabs is respectively connected with a plurality of second overcurrent isolation parts between the lead terminal and a connection part; a plurality of the second overcurrent isolation parts is disposed inside of the outer packaging; and the electrolyte is a solid electrolyte.

According to the ninth aspect of the present invention, it is possible to provide a solid-state battery of higher safety which can isolate an internal short circuit current flowing from inside of the solid-state battery to outside by the second overcurrent isolation part.

According to a tenth aspect of the present invention, in the battery as described in the ninth aspect, the second overcurrent isolation part is a fuse, and a part of a plurality of the collector tabs configures a part of the second overcurrent isolation part.

According to the tenth aspect of the present invention, it is possible to reduce the number of components and arrangement space of the solid-state battery.

According to an eleventh aspect of the present invention, in the battery as described in the tenth aspect, the second overcurrent isolation part includes a hole formed in the collector tab, and the hole is an elliptical shape.

According to the eleventh aspect of the present invention, it is possible to raise the fuse function of the second overcurrent isolation part, and possible to improve the strength of the collector tab.

### BRIEF DESCRIPTION OF THE DRAWINGS

FIG. 1 is a view showing an outline of a solid-state battery according to an embodiment of the present invention;

FIG. 2 is a sectional side elevation of a solid-state battery according to an embodiment of the present invention;

FIG. 3A is a sectional side elevation of a first overcurrent isolation part and second overcurrent isolation part according to a first embodiment of the present invention;

FIG. 3B is a sectional side elevation of a first overcurrent isolation part and second overcurrent isolation part according to a first embodiment of the present invention;

FIG. 4A is a view showing a second overcurrent isolation part 13a1 according to a second embodiment of the present invention;

FIG. 4B is a view showing a second overcurrent isolation part 13a1 according to a second embodiment of the present invention;

FIG. 4C is a view showing a second overcurrent isolation part 13a1 according to a second embodiment of the present invention;

FIG. 5A is a view showing a second overcurrent isolation part 13a2 according to a third embodiment of the present invention;

FIG. 5B is a view showing a second overcurrent isolation part 13a2 according to a third embodiment of the present invention;

FIG. 6A is a view showing a second overcurrent isolation part 13a3 according to a fourth embodiment of the present invention;

FIG. 6B is a view showing a second overcurrent isolation part 13a3 according to a fourth embodiment of the present invention;

FIG. 7A is a view showing a first overcurrent isolation part 210a according to a fifth embodiment of the present invention;

FIG. 7B is a view showing a first overcurrent isolation part 210a according to a fifth embodiment of the present invention;

FIG. 8A is a view showing a first overcurrent isolation part 210b according to a sixth embodiment of the present invention;

FIG. 8B is a view showing a first overcurrent isolation part 210b according to a sixth embodiment of the present invention;

FIG. 9 is a plan view showing a battery la according to a seventh embodiment of the present invention;

FIG. 10 is a view showing an outline of a battery 1b according to an eighth embodiment of the present invention; and

FIG. 11 is a cross-sectional view showing a first overcurrent isolation part 210e according to the eighth embodiment of the present invention.

### DETAILED DESCRIPTION OF THE INVENTION

Hereinafter, embodiments of the present invention will be explained while referencing the drawings.

However, the embodiments shown below are to exemplify the present invention, and the present invention is not to be limited to the following embodiments.

### First Embodiment

### Solid-State Battery

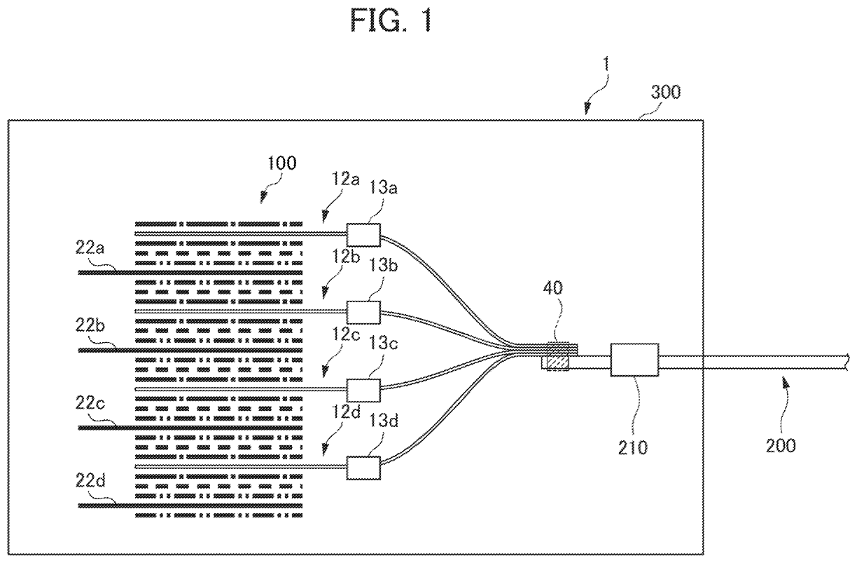

The solid-state battery 1 according to the present embodiment has a laminated body 100, lead terminal 200 and outer packaging 300, as shown in FIG. 1.

A plurality of negative electrode collector tabs 12a, 12b, 12c and 12d drawn from the end face of the laminated body 100 is bundled, and electrically connected with the lead terminal 200 in a connection part 40.
A part of the lead terminal 200 extends to outside of the outer packaging 300.
The second overcurrent isolation parts 13a, 13b, 13c and 13d are respectively provided between each of the plurality of anode collector tabs 12a, 12b, 12c and 12d and the connection part 40.

### (Laminated Body)

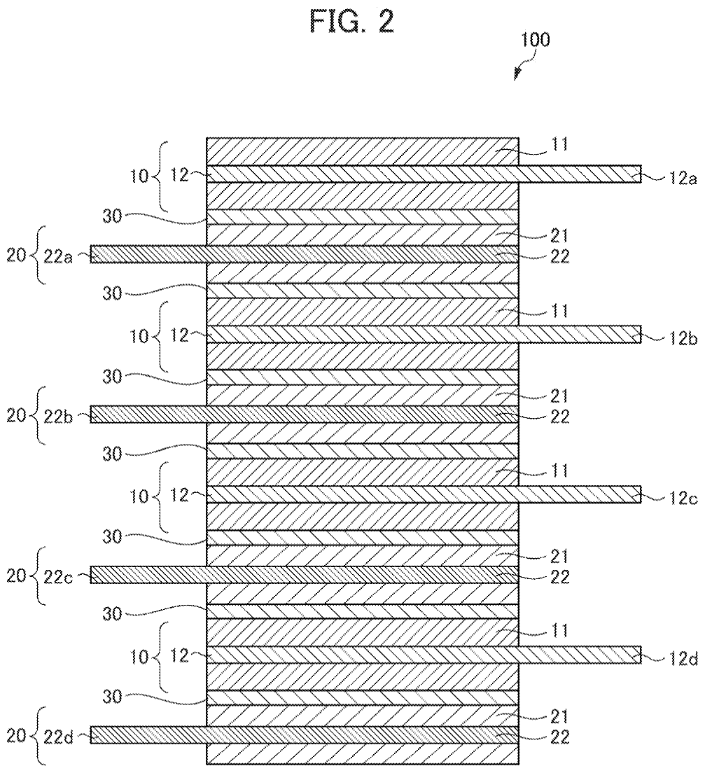

The laminated body 100 has a structure in which single batteries consisting of the negative electrode 10, positive electrode 20 and solid electrolyte 30 arranged therebetween are repeatedly laminated, as shown in FIG. 2.

The laminated body 100 according to the present embodiment is an example in which a total of four laminate units of the negative electrode 10, solid electrolyte 30 and positive electrode 20 are repeatedly laminated.

In the negative electrode 10, a negative electrode active material layer 11 is laminated on both sides of a negative electrode collector 12.

In the positive electrode 20, a positive electrode active material layer 21 is laminated on both sides of a positive electrode collector 22.
These may be separate layers, or the collector and active material layer may be integral.

### (Negative Electrode Active Material Layer)

The negative electrode active material constituting the negative electrode active material layer 11 is not particularly limited, and a known material as a negative electrode active material of solid-state batteries can be adopted.

The composition thereof is not particularly limited, and may contain solid electrolyte, conductive auxiliary agent, binder, etc.
As the negative electrode active material, for example, lithium alloys such as Li—Al alloy and Li—In alloy, lithium titanates such as Li₄Ti₅O₁₂, carbon materials such as carbon fiber and graphite, etc. can be exemplified.

### (Negative Electrode Collector)

The negative electrode collector 12 is not particularly limited, and a known collector which can be used in the negative electrode of a solid-state battery can be adopted.

For example, metal foils such as stainless steel (SUS) foil and copper (Cu) foil can be exemplified.

### (Positive Electrode Active Material Layer)

The positive electrode active material constituting the positive electrode active material layer 21 is not particularly limited, and a known material as the positive electrode active material of a solid-state battery can be adopted.

There are no particular limitations in the compositions thereof, and may contain solid electrolyte, conductive auxiliary agent, binder, etc. As the positive electrode active material, for example, transition metal chalcogenides such as titanium disulfide, molybdenum disulfide and niobium selenide, and transition metal oxides such as lithium nickelate (LiNiO₂), lithium manganese oxide (LiMnO₂, LiMn₂O₄), lithium cobalt oxide (LiCoO₂), etc. can be exemplified.

### (Positive Electrode Collector)

The positive electrode collector 22 is not particularly limited, and a known collector which can be used in the positive electrode of a solid-state battery can be adopted.

For example, metal foils such as stainless steel (SUS) foil and aluminum (Al) foil can be exemplified.

### (Collector Tab)

The plurality of negative electrode collector tabs 12a, 12b, 12c and 12d is drawn substantially in parallel in the same direction from one end face of the laminated body 100.

In the present embodiment, the above-mentioned negative electrode collector tabs are configured to extend from each of the negative electrode collectors 12.

Similarly, the plurality of positive electrode collector tabs 22a, 22b, 22c and 22d, for example, is drawn in a plane substantially in parallel in the same direction from the other end face of the laminated body 100.

The above-mentioned plurality of positive electrode collector tabs may be drawn from one end face of the laminated body 100, similarly to the negative electrode collector tabs.
The above-mentioned plurality of positive electrode collector tabs is configured to extend from the positive electrode collector 22.

In the present invention, the collector tabs may be drawn from each collector, and are not limited to extending, for example, or may be a member different from the negative electrode collector 12 or positive electrode collector 22.

The width of the collector tab is appropriately set so that the resistance of the collector tab part is made smaller depending on the proposed use, with the width of the material as a maximum; however, it is preferably 1 mm to 1,000 mm, and more preferably 2 mm to 300 mm. The thickness is generally on the order of 5 to 50 μm, and the drawing length is generally on the order of 5 to 50 mm.

The plurality of negative electrode collector tabs 12a, 12b, 12c and 12d is joined with the lead terminal 200 of the connection part 40 in a bundled state.

The joining method is not particularly limited, and a known method such as welding by resistance welding, ultrasonic welding or the like, and adhering.
As shown in FIG. 1, the above-mentioned plurality of collector tabs is respectively connected with each of the second overcurrent isolation parts 13a, 13b, 13c and 13d, between the end part on the side of the laminated body 100 thereof and the connection part 40 with the lead terminal 200.
The configuration of the above-mentioned second overcurrent isolation part is described in detail at a later stage.

### (Solid Electrolyte)

The solid electrolyte 30 is laminated between the negative electrode 10 and positive electrode 20, and is formed to be layered, for example.

The solid electrolyte 30 is a layer containing at least solid electrolyte material.
It is possible to perform charge transfer between the positive electrode active material and negative electrode active material via the above-mentioned solid electrolyte material.

The solid electrolyte material is not particularly limited; however, for example, it is possible to exemplify a sulfide solid electrolyte material, oxide solid electrolyte material, nitride solid electrolyte material, halogenide solid electrolyte material, etc.

### (Lead Terminal)

As shown in FIG. 1, the lead terminal 200 has one end side thereof electrically connected by welding or the like at the connection part 40 with the plurality of negative electrode collector tabs, and the other end side is extended from the outer packaging 300 to configure the electrode part of the solid-state battery.

The lead terminal 200 is not particularly limited, and preferably is a linear plate-shaped member having flexibility of aluminum (Al), copper (Cu) or the like.

Generally, the thickness of the lead terminal 200 is on the order of 0.05 to 5 mm, and is thicker than the thickness of the collector tab.

The lead terminal 200 is connected with the first overcurrent isolation part 210, at a location between the connection part 40 and outer packaging 300.

In other words, the first overcurrent isolation part 210 is arranged inside of the outer packaging 300.
The configuration of the first overcurrent isolation part 210 will be described in detail at a later stage.

### (Outer Packaging)

The outer packaging 300 houses the laminated body 100, first overcurrent isolation part 210 and second overcurrent isolation parts 13a, 13b, 13c and 13d.

The outer packaging 300 is not particularly limited, and a laminate cell consisting of laminate film can be exemplified, for example. The above-mentioned laminate cell, for example, has a multi-layer structure in which a heat fusion welded resin layer such as polyolefin are laminated on the surface to a metal layer consisting of aluminum, stainless steel (SUS) or the like.
Other than the above mentioned, the laminate cell may have a layer consisting of a polyamide such as nylon, a polyester such as polyethylene terephthalate, etc., a adhesive layer consisting of any laminate adhesive, and the like.

The above-mentioned laminate cell houses inside the laminated body 100, etc. by folding one rectangular laminate film so as to sandwich the laminated body 100, etc., and being sealed by a heat sealing method or the like, at the outer side of the laminated body 100, etc.

The outer packaging 300 is not limited to the above-mentioned laminate cell, for example, and may be an outer packaging made of metal formed in a cylindrical shape.

### (First Overcurrent Isolation Part)

The above-mentioned first overcurrent isolation part 210 is not particularly limited; however, for example, a blowout-type fuse which melts by overcurrent can be used.

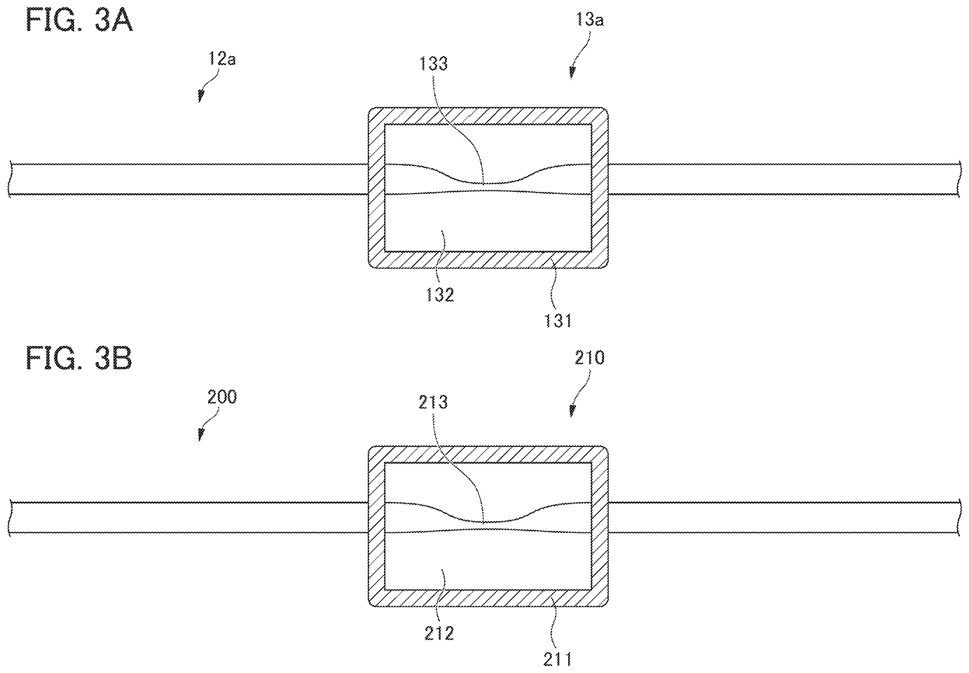

The first overcurrent isolation part 210 has a fuse element 213, as shown in FIG. 3B.
The fuse element 213 is a linear conductor through which electrical current flows, and at least one end is connected to the lead terminal 200.
When electrical current flows through the fuse element 213, heat is generated by the electrical resistance of the fuse element 213.
A rated current is set for the first overcurrent isolation part 210, and when overcurrent (fusing current) exceeding the above-mentioned rated current flows through the fuse element 213, the fuse element 213 melts from heat.
In the case of an abnormality occurring and overcurrent flowing to the first overcurrent isolation part 210, the fuse element 213 thereby melts and the overcurrent flowing to the lead terminal 200 is isolated. The above-mentioned overcurrent is an external short circuit current flowing to the solid-state battery 1 from outside of the solid-state battery 1, for example.
It is possible to protect the solid-state battery 1 from external short circuit current by the first overcurrent isolation part 210.

The first overcurrent isolation part 210 is arranged inside of the outer packaging 300.

It is thereby no longer necessary to arrange a fuse to a bus bar or the like outside of the solid-state battery 1, for example.
Therefore, it is possible to reduce the installation space of the solid-state battery 1, and resultingly possible to improve the energy density of the solid-state battery 1.

### (Second Overcurrent Isolation Part)

The second overcurrent isolation parts 13a, 13b, 13c and 13d are not particularly limited; however, for example, a blowout-type fuse which melts from overcurrent can be used similarly to the first overcurrent isolation part 210.

For example, as shown in FIG. 3A, the second overcurrent isolation part 13a electrically connected with the negative electrode collector tab 12a contains the fuse element 133.
The fuse element 133 is a linear conductor through which electrical current flows, and at least one end part is connected to the negative electrode collector tab 12a.
When electrical current flows through the fuse element 133, heat is generated by the electrical resistance of the fuse element 133.
A rated current is set for the second overcurrent isolation part 13a, and when overcurrent (fusing current) exceeding the above-mentioned rated current flows through the fuse element 133, the fuse element 133 melts from heat.
In the case of an abnormality occurring and overcurrent flowing to the second overcurrent isolation part 13a, the overcurrent flowing to the negative electrode collector tab 12a is isolated.
The above-mentioned overcurrent is an internal short circuit current flowing from inside of the solid-state battery 1 to outside, for example.

The second overcurrent isolation parts 13b, 13c and 13d have the same configuration as the second overcurrent isolation part 13a.

By the above-mentioned second overcurrent isolation parts being provided to each of the plurality of negative electrode collector tabs, in the case of an abnormality occurring at any location of the laminated body 100, it is possible to isolate only the abnormal location without stopping the entire solid-state battery 1.
Furthermore, it is possible to prevent overcurrent from flowing through the lead terminal 200 to outside.

The fuse element 133 of the second overcurrent isolation part 13a is housed in the fuse box 131, for example, and an arc-extinguishing material 132 is filled in the circumference of the fuse element 133. The second overcurrent isolation parts 13b, 13c and 13d have the same configuration.

The above-mentioned second overcurrent isolation parts are arranged inside of the outer packaging 300.

Since the second overcurrent isolation part is arranged close to the laminated body 100 at which the electrochemical reaction occurs, it is possible to shorten the time until the electrical current is isolated in the case of abnormality occurring, and thus possible to reduce the accident risk.
In addition to the above, by arranging the second overcurrent isolation part inside of the outer packaging 300, it is no longer necessary to arrange a fuse at the bus bar or the like outside of the solid-state battery 1, for example.
Therefore, it is possible to reduce the installation space of the solid-state battery 1, and resultingly possible to improve the volumetric energy density of the solid-state battery 1.

A part of the negative electrode collector tab 12a may be configured as the second overcurrent isolation part 13a to impart a function as the above-mentioned second overcurrent isolation part to the negative electrode collector tab 12a itself.

For example, the above-mentioned fuse element 133 may be configured as part of the negative electrode collector tab 12a.
It is thereby possible to reduce the number of components and arrangement space of the second overcurrent isolation part 13a.

The second overcurrent isolation part 13a may be configured as a separate body from the negative electrode collector tab 12a.

In this case, the second overcurrent isolation part 13a and lead terminal 200 are connected by a member other than the negative electrode collector tab 12a.
For the above-mentioned member, the material and shape are not particularly limited so long as the electrical connection is ensured.

It should be noted that, although omitted from illustration in FIG. 1, a second overcurrent isolation parts having the same configuration as described above may also be respectively provided between the end part on the laminated body 100 side of each of the plurality of positive electrode collector tabs 22a, 22b, 22c and 22d, and the connection part with the lead terminal.

In the present embodiment, in addition to the above-mentioned first overcurrent isolation part 210, it is preferable for the second overcurrent isolation parts 13a, 13b, 13c and 13d to be arranged. Since two overcurrent isolation parts are arranged in the path in which electrical current flows between the solid-state battery 1 and outside, it is possible to further improve the safety of the solid-state battery 1.

In the case of using the above-mentioned second overcurrent isolation part together with the above-mentioned first overcurrent isolation part, the rated current of the above-mentioned first overcurrent isolation part is preferably greater than the rated current of the above-mentioned second overcurrent isolation part.
Even in a case of jointly using the two overcurrent isolation parts, the effect of isolating only the abnormal location of the laminated body 100 can thereby be obtained by the above-mentioned second overcurrent isolation part.

Hereinafter, other embodiments of the present invention will be explained.

Explanation may be omitted for configurations which are the same as the above first embodiment.

### Second Embodiment

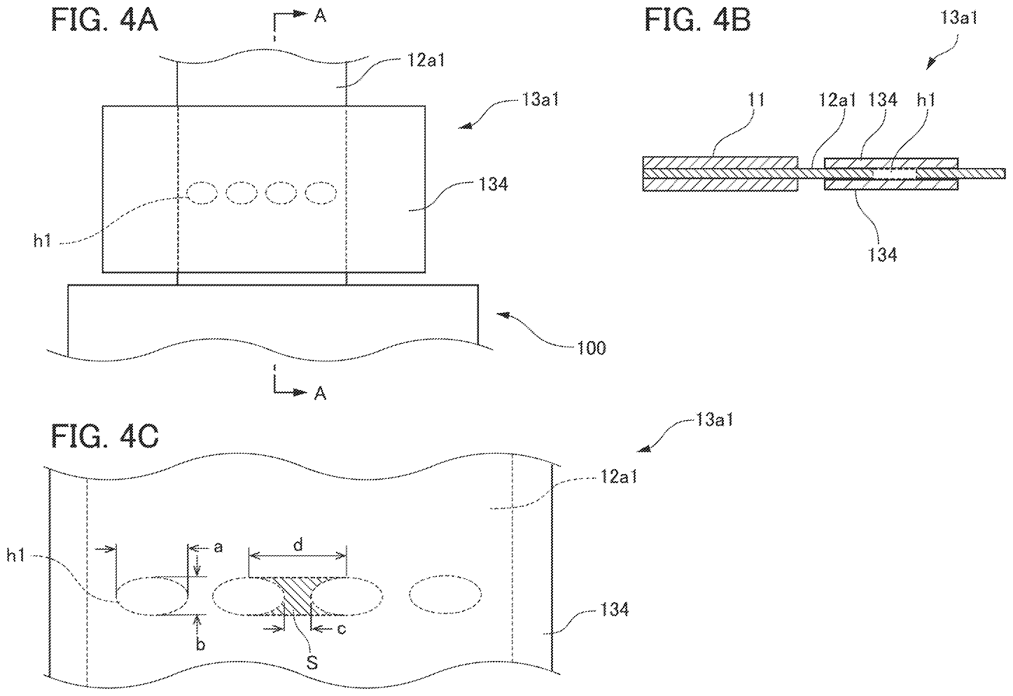

FIG. 4 is a view showing a second overcurrent isolation part 13a1 according to a second embodiment.

FIG. 4A is a plan view, FIG. 4B is a cross-sectional view along the line A-A in FIG. 4A, and FIG. 4C is a required part enlarged view of FIG. 4A.

The second overcurrent isolation part 13a1 according to the present embodiment is a fuse, and is configured as part of the negative electrode collector tab 12a1, as shown in FIG. 4A.

The second overcurrent isolation part 13a1 is configured by one or a plurality of holes h1 being formed in part of the negative electrode collector tab 12a1.
Since the location at which the hole h1 of the negative electrode collector tab 12a1 was formed is preferentially melted upon overcurrent flowing, it is thereby possible to impart a fuse function to the negative electrode collector tab 12a1.

The hole h1 is formed in a circular shape or elliptical shape, polygonal shape or a combination of these, for example.

The hole h1 is preferably an elliptical shape.
In detail, as shown in FIG. 4C, the relationship between the diameter a of the hole h1 and the diameter b in the perpendicular direction to the diameter a is preferably b/a≤1.
Then, as shown in FIG. 4, the long axis direction of the hole h1 of elliptical shape is preferably arranged perpendicularly to the extending direction of the negative electrode collector tab 12a1. Since it is thereby possible to narrow the interval c between end parts of the holes h1, the fuse function can be improved.
In addition to the above mentioned, since it is possible to widen the interval d between the holes h1, the area S between adjacent holes h1 can be widened, and thus the strength of the negative electrode collector tab 12a1 can be improved.
An insulating material or the like may be filled in the void of the hole h1.

The upper face and lower face of the location where the hole h1 of the negative electrode collector tab 12a1 was formed may be covered by the insulating material 134, as shown in FIGS. 4A and B.

It is thereby possible to further improve the strength of the negative electrode collector tab 12a1.
The insulating material 134 can be configured by a film, tape or the like having an electrical insulating property.
Upon overcurrent flowing and the second overcurrent isolation part 13a1 being melted, the insulating materials 134 adhere by the fusing heat and the electrical insulating property is ensured, and it is possible to suppress secondary short circuit by sliding of the negative electrode collector tab 12a1.
The insulating material 134 also has a suppression effect of sagging, wrinkling, etc. upon welding the lead terminal 200 and negative electrode collector tab 12a1.

### Third Embodiment

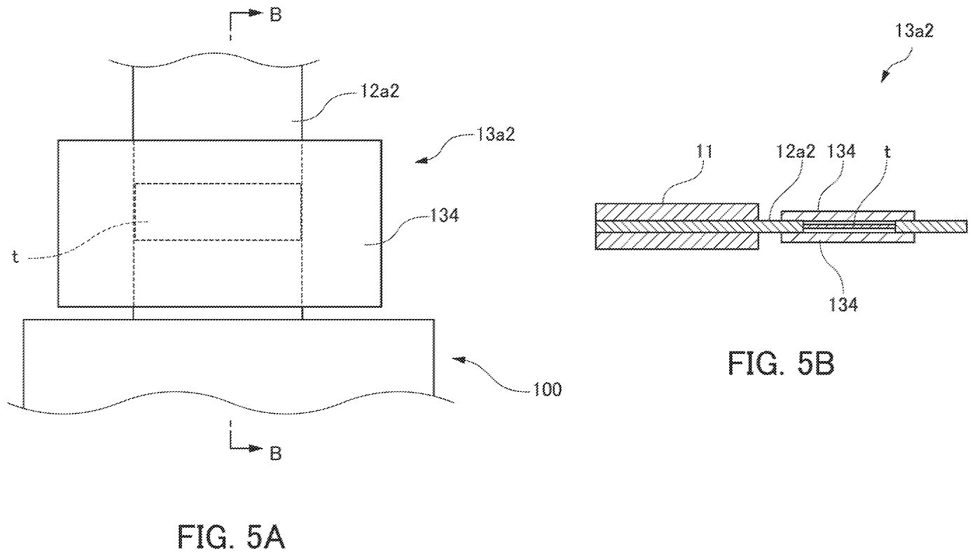

FIG. 5 is a view showing a second overcurrent isolation part 13a2 according to a third embodiment.

FIG. 5A shows a plan view, and FIG. 5B shows a cross-sectional view along the line B-B in FIG. 5A.

The second overcurrent isolation part 13a2 is configured as part of the negative electrode collector tab 12a2, as shown in FIG. 5A. The second overcurrent isolation part 13a2 is formed by a fusing part t being provided at a part of the negative electrode collector tab 12a2.

The fusing part t is a member of thinner thickness than the negative electrode collector tab 12a2, for example.

The fusing part t may be configured by thinning the thickness of part of the negative electrode collector tab 12a2, or may be configured as a different member than the negative electrode collector tab 12a2, for example, as a clad metal.

In this case, the melting point of the fusing part t may be lower than the negative electrode collector tab 12a2.

Alternatively, the resistance value of the fusing part t may be made higher than the negative electrode collector tab 12a2.
It is thereby possible to arbitrarily set the thickness of the fusing part t.

The upper face and lower face of the location at which the fusing part t of the negative electrode collector tab 12a2 is formed may be covered by the insulating material 134, similarly to the second embodiment.

### Fourth Embodiment

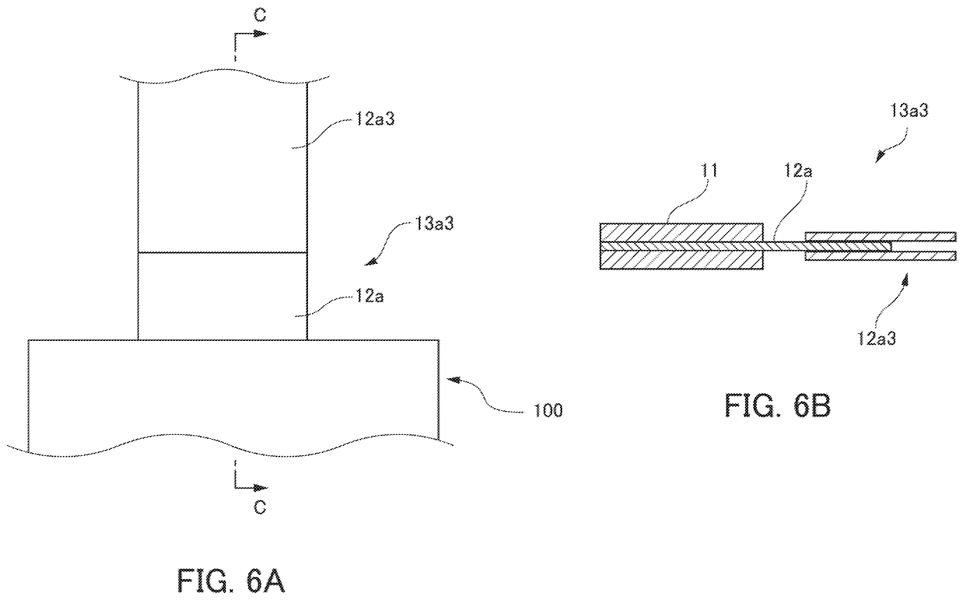

FIG. 6 is a view showing a second overcurrent isolation part 13a3 according to a fourth embodiment.

FIG. 6A shows a plan view, and FIG. 6B shows a cross-sectional view along the line C-C in FIG. 6A.

The second overcurrent isolation part 13a3 is configured as a part of the negative electrode collector tab 12a3, as shown in FIG. 6A. The second overcurrent isolation part 13a3, for example, is configured by a negative electrode collector tab 12a consisting of a sheet of current collecting foil, and a negative electrode collector tab 12a3 consisting of two sheets of current collecting foil being welded. Since the negative electrode collector tab 12a having small cross-sectional area is preferentially melted upon overcurrent flowing, it is thereby possible to impart a fuse function to the second overcurrent isolation part 13a3.

An insulator such as an insulating film or alumina may be covered or coated on the negative current collector tab 12a.
So long as the negative electrode collector tab 12a has a smaller number of sheets of current collecting foil than the negative electrode collector tab 12a3, the number of sheets of current collecting foil is not particularly limited.

### Fifth Embodiment

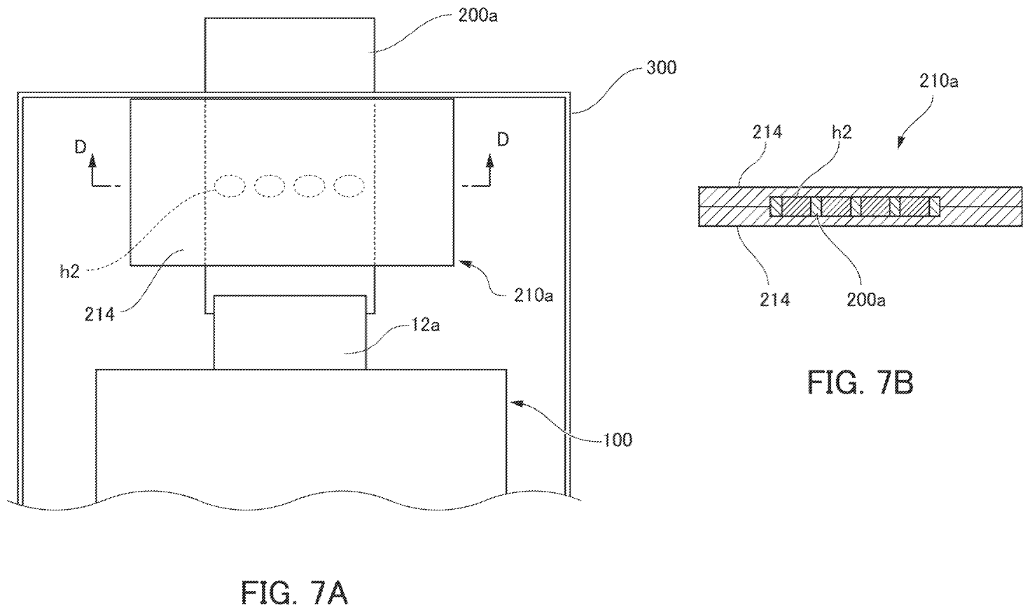

FIG. 7 is a view showing a first overcurrent isolation part 210a according to a fifth embodiment.

FIG. 7A shows a plan view, and FIG. 7B shows a cross-sectional view along the line D-D in FIG. 7A.

The first overcurrent isolation part 210a according to the present embodiment is configured as part of the lead terminal 200a. The first overcurrent isolation part 210a is configured by one or a plurality of holes h2 being formed in part of the lead terminal 200a, similarly to the second overcurrent isolation part 13a1 according to the second embodiment.

The shape of the hole h2 is not particularly limited; however, it is preferably elliptical, similarly to the hole h1.

In detail, similarly to the configuration shown in FIG. 4C, the relationship between the diameter a of the hole h2 and the diameter b in a direction perpendicular to the diameter a is preferably b/a≤1. Then, the long axis direction of the hole h2 of elliptical shape is preferably arranged perpendicularly to the extending direction of the lead terminal 200a.
It is thereby possible to raise the fuse function, and possible to improve the strength of the lead terminal 200a.

In addition, a heat insulating material or insulating material, reinforcing material, or the like may be filled into the hole h2.

The upper face and lower face of the location at which the hole h2 of the lead terminal 200a is formed are covered by a sealing material 214 for preventing intrusion of open air.

The sealing material 214 has an insulating property similarly to the insulating material 134, and has a function of sticking the lead terminal 200a and outer packaging 300, and preventing intrusion of open air to the outer packaging 300.

By such a sealing material 214, it is possible to improve the insulating property, sealing property and strength of the first overcurrent isolation part 210a.
In addition to the above mentioned, since the sealing material 214 is a component normally used as a component of the battery 1, it is possible to configure the battery 1 without requiring an increase in new components, it is possible to improve the volumetric energy density, and can also reduce cost.
The same material as the sealing material 214 may be filled in the hole h2.

### Sixth Embodiment

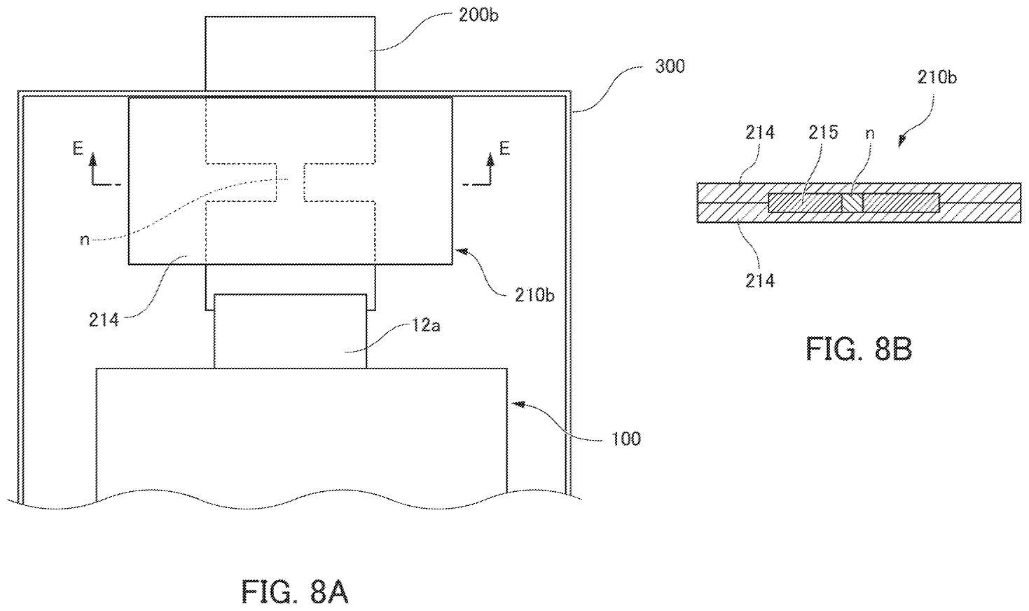

FIG. 8 is a view showing a first overcurrent isolation part 210b according to a sixth embodiment.

FIG. 8A shows a plan view, and FIG. 8B is a cross-sectional view along the line E-E in FIG. 8A.

The first overcurrent isolation part 210b according to the present embodiment is configured as a part of a lead terminal 200b.

A narrow part n is formed in the lead terminal 200b.
Since the narrow part n is preferentially melted upon overcurrent flowing, it is thereby possible to impart a fuse function to the first overcurrent isolation part 210b.

The upper face and lower face of a location at which the narrow part n is formed of the lead terminal 200b are covered by the sealing material 214, similarly to the lead terminal 200a.

In a void 215 between the sealing material 214 and narrow part n, an insulating material or reinforcing material is filled.
The same material as the sealing material 214 may be filled into the void 215.

### Seventh Embodiment

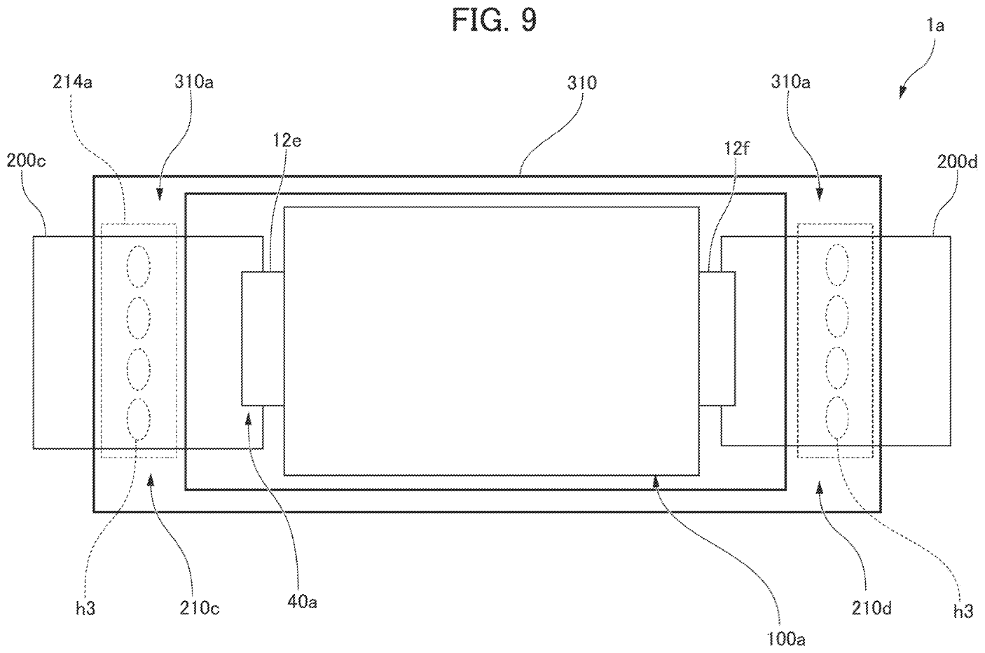

FIG. 9 is a plan view showing a battery la according to a seventh embodiment.

The battery 1a may be a solid-state battery including a solid electrolyte, or may be a liquid-based battery including a liquid electrolyte.
The battery 1a has a laminated body 100a, lead terminals 200c and 200d, and outer packaging 310, as shown in FIG. 9.
First overcurrent isolation parts 210c and 210d are provided to the lead terminals 200c and 200d.
The first overcurrent isolation parts 210c and 210d are configured as parts of the lead terminals 200c and 200d.
The first overcurrent isolation parts 210c and 210d are configured by one or a plurality of holes h3 being formed, for example.
The first overcurrent isolation parts 210c and 210d are arranged in an adhered part 310a in which outer packaging parts 310 are adhered.

By the first overcurrent isolation parts 210c and 210d being arranged at the adhered part 310a, even in a case of the first overcurrent isolation parts 210c and 210d being melted, a spark is prevented from reaching the laminated body 100a.

For this reason, it is possible to configure the battery 1a as a liquid-based battery including a liquid electrolyte.
The first overcurrent isolation parts 210c and 210d are sealed by the sealing material 214a.
There may be one of either of the first overcurrent isolation parts 210c and 210d.

### Eighth Embodiment

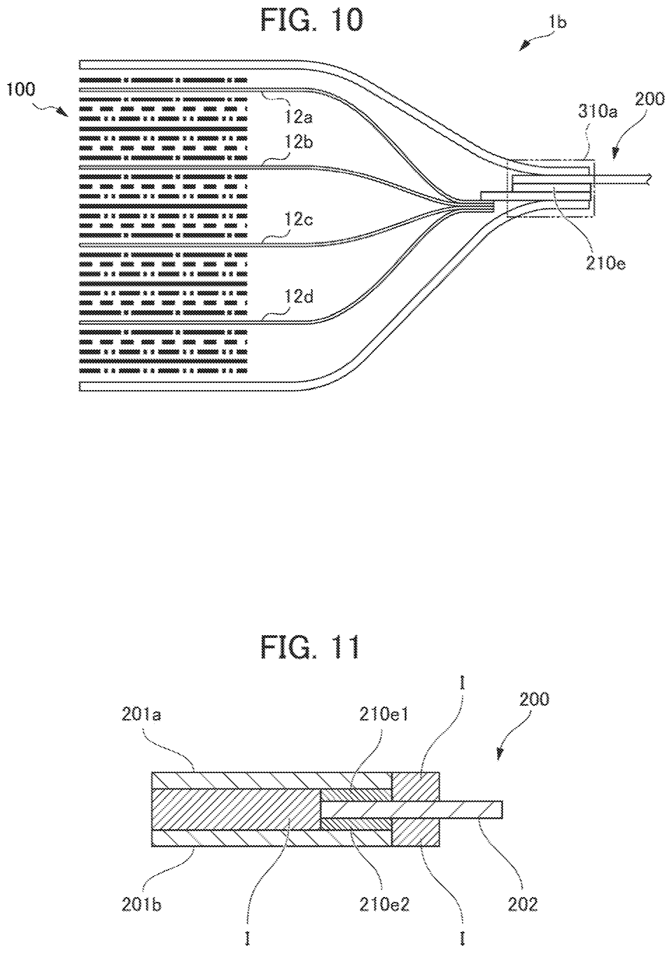

FIG. 10 is a view showing an outline of a battery 1b according to an eighth embodiment, and is a sectional schematic diagram viewing the battery 1b from a side.

As shown in FIG. 10, the battery 1b has a first overcurrent isolation part 210e.

The first overcurrent isolation part 210e is provided between the lead terminal 200, and the plurality of negative electrode collector tabs 12a, 12b, 12c and 12d.
The first overcurrent isolation part 210e is arranged at the adhered part 310a of the outer packaging.
The battery 1b may be a solid-state battery including a solid electrolyte, or may be a liquid-based battery including a liquid electrolyte.

The first overcurrent isolation part 210e is a PTC thermistor. The PTC thermistor rapidly increases the resistance value when exceeding a certain temperature (Curie temperature).

During normal operation, the PTC thermistor is energizable; however, when overcurrent flows through the PTC thermistor, the resistance value increases by self-heating from Joule heat, and the electrical current flowing through the PTC thermistor decays.
The overcurrent flowing through the PTC thermistor is thereby isolated. By using the PTC thermistor as the first overcurrent isolation part 210e, it is possible continuously use the battery 1b, without requiring the replacement of components even after the occurrence of overcurrent.
The PTC thermistor is not particularly limited, and it is possible to use a semiconductor ceramic or the like with barium titanate as the main component, for example, and the Curie temperature can be set arbitrarily according to the material composition thereof.

FIG. 11 is a sectional schematic diagram for explaining the configuration of the first overcurrent isolation part 210e.

As shown in FIG. 11, the first overcurrent isolation part 210e consists of the two first overcurrent isolation parts 210e1 and 210e2. The first overcurrent isolation part 210e1 is provided to be electrically connected with each member between a connection plate 201a and a lead tab 202.
Similarly, the first overcurrent isolation part 210e2 is provided to be electrically connected with each member between a connection plate 201b and lead tab 202.
The connection plate 201a and connection plate 201b are electrically connected with the plurality of negative electrode collector tabs 12a, 12b, 12c and 12d.
The lead tab 202 is a part of the lead terminal 200, and is extended from the outer packaging 300 to configure an electrode part of the battery 1b.
The lead tab 202, connection plate 201a and connection plate 201b are electrically insulated by an insulation member I.
The connection plate 201a and connection plate 201b are electrically insulated by the insulation member I.

The first overcurrent isolation parts 210e1 and 210e2, and the connection plates 201a and 201b are provided in two groups in the present embodiment; however, they may be one group, may be provided in three or more groups, and are preferably provided as a plurality of groups.

In the case of providing the first overcurrent isolation part and connection plates as a plurality of groups, the plurality of first overcurrent isolation parts are independently connected respectively with a single different negative electrode collector tab or a pair of different negative electrode collector tabs via the connection plate. In the case of overcurrent occurring by internal short circuit, for example, in the battery 1b, the overcurrent flowing from the connection plate connected to a location at which the internal short circuit occurred to the side of the lead tab 202 is isolated; however, electrical current flowing from the connection plate connected to a location at which an internal short circuit is not occurring to the side of the lead tab 202 is maintained.
Therefore, during the occurrence of internal short circuit, a device to which the battery 1b is connected is not made to stop, and it is possible to prevent overcurrent from flowing through the lead terminal 200 to outside.

Although preferred embodiments of the present invention have been explained above, the present invention is not to be limited to the above-mentioned embodiments, and embodiments arrived at by applying appropriate modifications within a scope not inhibiting the effects of the present invention shall also be encompassed by the scope of the present invention.

In FIG. 1, the second overcurrent isolation parts 13a, 13b, 13c and 13d are provided to be corresponding to all of the negative electrode collector tabs 12a, 12b, 12c and 12d.

However, it is not limited to the above.
For example, the negative electrode collector tabs may be divided into groups consisting of a plurality of negative electrode collector tabs, and electrically connected with the above-mentioned second overcurrent isolation part for every group.

In the above embodiments, the second overcurrent isolation part was explained in the second, third, and fourth embodiments, and the first overcurrent isolation part was explained in the fifth and sixth embodiments.

These can be freely combined.

### EXPLANATION OF REFERENCE NUMERALS

1, 1a battery

10 negative electrode

12 negative electrode collector

12a, 12b, 12c, 12d negative electrode collector tab

13a, 13b, 13c, 13d second overcurrent isolation part

20 positive electrode

22 positive electrode collector

22a, 22b, 22c, 22d positive electrode collector tab

30 solid electrolyte

40 connection part

100 laminated body

200 lead terminal

210 first overcurrent isolation part

300, 310 outer packaging

310a adhered part

What is claimed is:

1. A battery comprising: a laminated body in which a positive electrode including a positive electrode collector, an electrolyte and a negative electrode including a negative electrode collector are repeatedly disposed, at least any among the positive electrode collector and the negative electrode collector is respectively drawn out from an end face, and configures a plurality of collector tabs;
an outer packaging which houses the laminated body; and
a lead terminal which is electrically connected with a plurality of the collector tabs, and having a part which extends from the outer packaging to outside,
wherein the lead terminal is connected with a first overcurrent isolation part disposed inside of the outer packaging.

2. The battery according to claim 1, wherein the first overcurrent isolation part is a PTC thermistor.

3. The battery according to claim 2, wherein a plurality of the first overcurrent isolation part is provided, each being connected with a different one of the collector tabs.

4. The battery according to claim 1, wherein the first overcurrent isolation part is a fuse, and a part of the lead terminal configures a part of the first overcurrent isolation part.

5. The battery according to claim 4, wherein the first overcurrent isolation part includes a hole formed in the lead terminal, and the hole is elliptical shape.

6. The battery according to claim 5, wherein the hole has a long axis direction of the elliptical shape disposed perpendicular to an extending direction of the lead terminal.

7. The battery according to claim 5, wherein at least any among an insulating material, a heat insulating material, a reinforcing material and sealing material is filled in at least part of the hole.

8. The battery according to claim 6, wherein at least any among an insulating material, a heat insulating material, a reinforcing material and sealing material is filled in at least part of the hole.

9. The battery according to claim 1, wherein the outer packaging has an adhered part, and the first overcurrent isolation part is disposed at the adhered part.

10. The battery according to claim 1, wherein a plurality of the collector tabs is respectively connected with a plurality of second overcurrent isolation parts between the lead terminal and a connection part,
wherein a plurality of the second overcurrent isolation parts is disposed inside of the outer packaging, and
wherein the electrolyte is a solid electrolyte.

11. The battery according to claim 10, wherein the second overcurrent isolation part is a fuse, and a part of a plurality of the collector tabs configures a part of the second overcurrent isolation part.

12. The battery according to claim 11, wherein the second overcurrent isolation part includes a hole formed in the collector tab, wherein the hole is an elliptical shape.
